(19) United States
(12) Patent Application Publication
(10) Pub. No.: US 2026/0099428 A1
(43) Pub. Date: Apr. 9, 2026

(54) SMART SCRIPT CODING FRAMEWORK FOR SYSTEM TEST

(71) Applicant: Dell Products L.P., Round Rock, TX (US)

(72) Inventors: John Jun Liu, Chengdu (CN); Huijuan Fan, Chengdu (CN)

(73) Assignee: Dell Products L.P., Round Rock, TX (US)

(21) Appl. No.: 18/919,525

(22) Filed: Oct. 18, 2024

(30) Foreign Application Priority Data
Oct. 8, 2024 (CN) 202411393677.6

(51) Int. Cl. G06F 11/36; G06F 11/34

(52) U.S. Cl. CPC G06F 11/3672; G06F 11/3414

(57) ABSTRACT

Methods, system, and non-transitory processor-readable storage medium for a test script coding system are provided herein. An example method includes receiving a request, by the test script coding system, to generate a test script for testing at least one test system. The test script coding system generates a directed acyclic graph (DAG) representing test actions to execute during the testing, wherein the test script comprises test steps comprising the test actions.

### FIELD

The field relates generally to automating generation of test scripts in information processing systems.

### BACKGROUND

An automated test script allows a software tester to test each level of a wide range of devices systematically, covering multiple product components. Test scripts are usually logically complex, intended to test multiple features that have dependencies and/or iterative relationships. There may be thousands of test scripts for complicated information processing systems, such as storage products.

### SUMMARY

Illustrative embodiments provide techniques for implementing a test script coding system in a storage system. For example, illustrative embodiments receive a request, by a test script coding system, to generate a test script for testing at least one test system. The test script coding system generates a directed acyclic graph (DAG) representing test actions to execute during the testing, where the test script comprises test steps comprising the test actions. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a test script coding system in an illustrative embodiment.

FIG. 2 shows a test script coding system in an illustrative embodiment.

FIG. 3 shows a flow diagram of a process for a test script coding system in an illustrative embodiment.

FIG. 4 illustrates a target manager in communication with a step manager in an illustrative embodiment.

FIG. 5 illustrates labels within individual test targets, in an illustrative embodiment.

FIG. 6 illustrates a test step performing operations on one or more test targets in an illustrative embodiment.

FIG. 7 illustrates the interaction between test steps and the test target pool in an illustrative embodiment.

FIG. 8 illustrates the normal synchronous execution model in an illustrative embodiment.

FIG. 9 illustrates the exclusive synchronous execution model in an illustrative embodiment.

FIG. 10 illustrates the thread asynchronous execution model in an illustrative embodiment.

FIG. 11 illustrates the threads asynchronous execution model in an illustrative embodiment.

FIG. 12 illustrates the visual representation of the DAG created by the test script coding system in an illustrative embodiment.

FIG. 13 illustrates the step manager traversing the DAG in an illustrative embodiment.

FIG. 14 illustrates an example DAG related to obtaining snapshots on a volume in an example embodiment.

FIGS. 15 and 16 show examples of processing platforms that may be utilized to implement at least a portion of a test script coding system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a test script coding system, which technique may be used to provide, among other things automated generation of test scripts to achieve efficient testing coverage by receiving a request, by a test script coding system, to generate a test script for testing at least one test system. The test script coding system generates a directed acyclic graph (DAG) representing test actions to execute during the testing, where the test script comprises test steps comprising the test actions. Other types of processing devices can be used in other embodiments.

Test scripts need to simulate real user scenarios, which are complex, random, and concurrent. There may be many participants in the real user scenarios, such as lab administrators, system administrators, applications that are executing, different users, and the actual system itself. There may be multiple different configurations for different businesses, and many different actions for different types of support. From a system test point of view, the different user scenarios are very large, can occur randomly, and can run for an extended period of time. Different user scenarios may happen concurrently where some of the actions may impact other actions, and some actions will not.

Conventional technologies fail to create test scripts that truly mimic user scenarios where users may perform operations with some level of randomness, concurrently with other users. Conventional technologies for creating test scripts create scripts that have a fixed sequence, running the same commands in the same order every time. Conventional technologies fail to take into account that in complex and high concurrency systems, the order of commands can greatly affect the outcome of whether a test script passes or fails. Conventional technologies require that test script designers develop multiple test scripts that run concurrently with threads or processes, yet do not communicate with other test scripts to coordinate operations, resulting in bottlenecks. Conventional technologies fail to adapt to more complex test scenarios. Conventional technologies organize test actions linearly over time, but fail to recreate real life scenarios which are complex, random, and occur concurrently.

By contrast, in at least some implementations in accordance with the current technique as described herein automatically generate test scripts to achieve efficient testing coverage by receiving a request, by a test script coding system, to generate a test script for testing at least one test system. The test script coding system generates a directed acyclic graph (DAG) representing test actions to execute during the testing, where the test script comprises test steps comprising the test actions. Other types of processing devices can be used in other embodiments.

Thus, a goal of the current technique is to provide a method and a system for a test script coding system that provides a framework for creating test scripts using a directed acyclic graph (DAG) that are flexible, adaptable, and scalable. Another goal is to provide a framework that creates test scripts that truly mimic user scenarios. Another goal is to provide a framework that creates test scripts that communicate with other test scripts to coordinate operations, to avoid bottlenecks. Another goal is to provide a framework that adapts to more complex test scenarios. Another goal is to provide a framework that recreates real life scenarios which are complex, random, and occur concurrently.

In at least some implementations in accordance with the current technique described herein, the use of a test script coding system can provide one or more of the following advantages: creating test scripts using a directed acyclic graph (DAG) that are flexible, adaptable, and scalable, creating test scripts that truly mimic user scenarios, providing a framework that creates test scripts that communicate with other test scripts to coordinate operations to avoid bottlenecks, providing a framework that adapts to more complex test scenarios, and providing a framework that recreates real life scenarios which are complex, random, and concurrent.

In contrast to conventional technologies, in at least some implementations in accordance with the current technique as described herein, test scripts are automatically generated to achieve efficient testing coverage by receiving a request, by a test script coding system, to generate a test script for testing at least one test system. The test script coding system generates a directed acyclic graph (DAG) representing test actions to execute during the testing, where the test script comprises test steps comprising the test actions. Other types of processing devices can be used in other embodiments.

In an example embodiment of the current technique, the test script coding system creates a visual representation of the DAG representing a test structure of the test script.

In an example embodiment of the current technique, the test script coding system executes the test script defined by the DAG.

In an example embodiment of the current technique, the DAG comprises vertices and edges, where the vertices comprise the test steps, and where the edges comprise relationships between the test steps.

In an example embodiment of the current technique, the test script coding system a target manager manages a plurality of test targets, where a test target comprises a data dictionary for a test object accessed by the test script during the execution of the test script, where the test script coding system comprises the target manager.

In an example embodiment of the current technique, the data dictionary comprises at least one label, where at least one label supports at least one logical operator comprising at least one of “and”, “or”, and “not”.

In an example embodiment of the current technique, the target manager provides at least one test target function to control test targets.

In an example embodiment of the current technique, at least one test target function comprises at least one of a test target add function, test target get function, and test target delete function.

In an example embodiment of the current technique, the test target add function creates a unique identifier for the test target.

In an example embodiment of the current technique, the test target get function comprises a count attribute.

In an example embodiment of the current technique, a step manager manages execution of the test steps according to the DAG, where the test script coding system comprises the step manager, where the test step performs at least one test action on a test target.

In an example embodiment of the current technique, the test step receives, as input, the test target from a target manager, where the test script coding system comprises the target manager.

In an example embodiment of the current technique, the test step provides as output, at least one new test target to the target manager.

In an example embodiment of the current technique, the test step updates the test target that is received as input from the target manager.

In an example embodiment of the current technique, the step manage executes test steps according to an execution model, where the execution model comprises at least one of normal synchronous execution, exclusive synchronous execution, thread asynchronous execution, and threads asynchronous execution, and where the test script coding system comprises the step manager.

In an example embodiment of the current technique, the test script coding system defines at least one relationship in an execution timeline between one or more test steps, where at least one relationship comprises a follow relationship, a conflict relationship and a wait relationship, where at least one relationship manages execution order between the one or more test steps.

In an example embodiment of the current technique, the test script coding system defines a global data structure comprising a key and value, where a step manager comprises the global data structure, where the test step communicates with another test step using the global data structure, and where the test script coding system comprises the step manager.

In an example embodiment of the current technique, the global data structure is used to manage at least one of locks and messages used in communication between test steps.

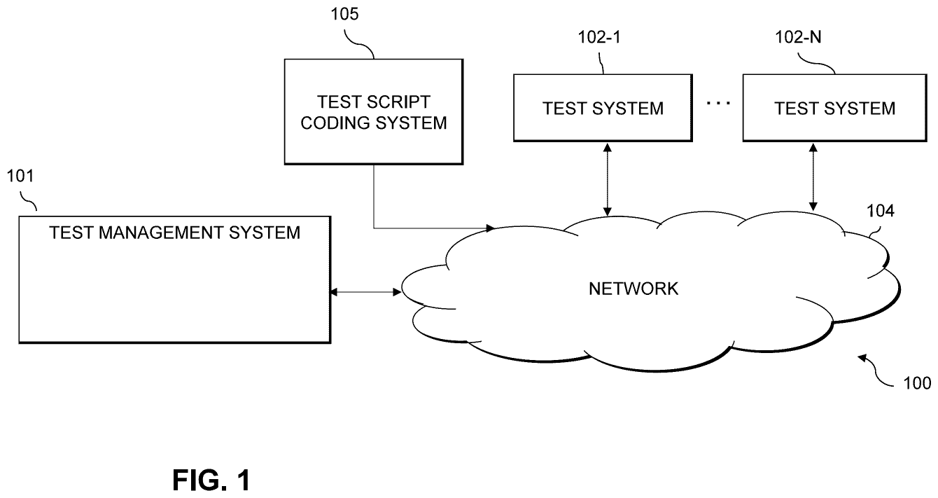

FIG. 1 shows a computer network (also referred to herein as an information processing system) 100 configured in accordance with an illustrative embodiment. The computer network 100 comprises a test management system 101, test script coding system 105, and test systems 102-N. The test management system 101, test script coding system 105, and test systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a test script coding system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the test systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The test systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the test script coding system 105 are one or more input-output devices, which illustratively comprise keyboards, displays or other types of input-output devices in any combination. Such input-output devices can be used, for example, to support one or more user interfaces to the test script coding system 105, as well as to support communication between the test script coding system 105 and other related systems and devices not explicitly shown. For example, a dashboard may be provided for a user to view a progression of the execution of the test script coding system 105. One or more input-output devices may also be associated with any of the test systems 102-N.

Additionally, the test script coding system 105 in the FIG. 1 embodiment is assumed to be implemented using at least one processing device. Each such processing device generally comprises at least one processor and an associated memory, and implements one or more functional modules for controlling certain features of the test script coding system 105.

More particularly, the test script coding system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the test script coding system 105 to communicate over the network 104 with the test management system 101, and test systems 102-N and illustratively comprises one or more conventional transceivers.

A test script coding system 105 may be implemented at least in part in the form of software that is stored in memory and executed by a processor, and may reside in any processing device. The test script coding system 105 may be a standalone plugin that may be included within a processing device.

It is to be understood that the particular set of elements shown in FIG. 1 for test script coding system 105 involving the test management system 101, and test systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the test script coding system 105 can be on and/or part of the same processing platform.

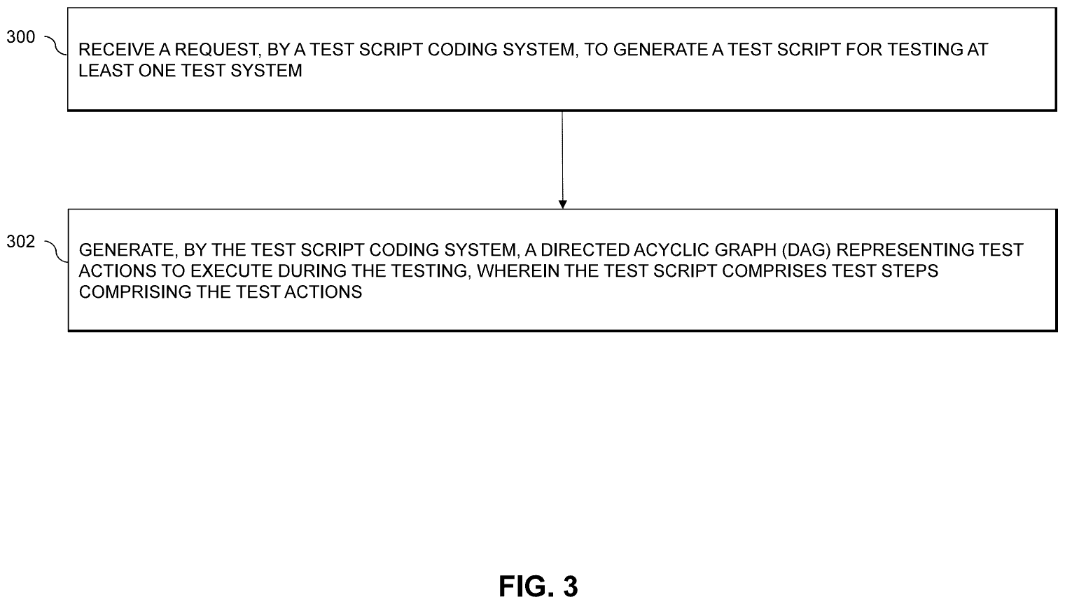

An exemplary process of test script coding system 105 in computer network 100 will be described in more detail with reference to, for example, the flow diagram of FIG. 3.

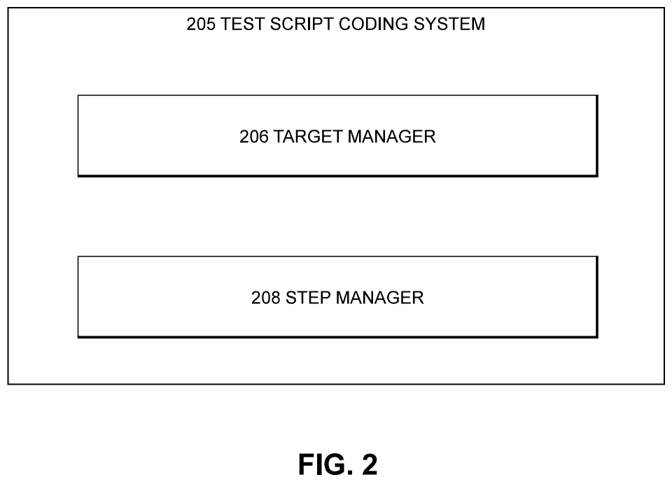

FIG. 2 shows a test script coding system 205 in an illustrative embodiment. In an example embodiment, the test script coding system 205 comprises the target manager 206, and the step manager 208. The target manager 206 manages test targets and provides proper test targets to the step manager 208. The step manager 208 executes the test steps using step models which are explained in further details below.

FIG. 3 is a flow diagram of a process for execution of the test script coding system 105 in an illustrative embodiment. It is to be understood that this particular process is only an example, and additional or alternative processes can be carried out in other embodiments.

At 300, the test script coding system 105 receives a request, to generate a test script for testing at least one test system. For example, the test management system 101 may receive the request, and in turn, transmit the request to the test script coding system 105. Or, the test script coding system 105 may receive the request directly. Once the test script coding system 105 executes the test script(s). the test script coding system 105 may transmit the results of the test script(s) to the test management system 101.

At 302, the test script coding system 105 generates a directed acyclic graph (DAG) representing test actions to execute during the testing, where the test script comprises test steps comprising the test actions. The test script coding system 105 organizes the test actions as a DAG over a timeline. In an example embodiment, the DAG comprises vertices and edges, where the vertices comprise the test steps, and where the edges comprise relationships between the test steps.

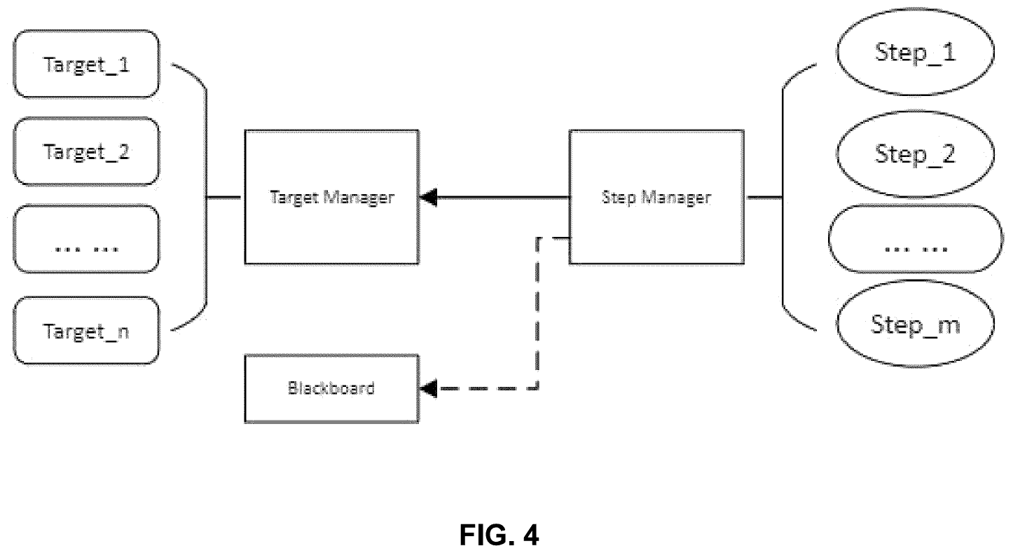

In an example embodiment, target manager 206 manages a plurality of test targets, and provides test targets to the step manager 208. FIG. 4 illustrates the target manager 206 in communication with the step manager 208, where the test targets are labelled as “Target_1”, for example, and the test steps are labelled as “Step_1”, for example. Blackboard is a global data structure that is used to manage at least one of locks and messages used in communication between test steps.

In an example embodiment, a test target comprises a data dictionary for a test object accessed by the test script during the execution of the test script. For example, a test object may be, but is not limited to, a volume, snapshot, protection policy, virtual machine, etc. The data dictionary for a test object may contain information associated with the test object that will be accessed by test scripts. An example data dictionary is illustrated below:

{
“name”: xxxx,
“obj”: xxxx,
“description”: xxxx,
.... ....
“labels”: [label_1, label]2, ...]
}

As illustrated above, a key attribute of the test target is called “label”. This key attribute is a list, and is used to store a plurality of labels defined for different test targets. In an example embodiment, a test target pool comprises a plurality of test targets. These test targets are shared by different test steps with different purposes. In an example embodiment, a test step processes a set of test targets. In an example embodiment, a label is defined to represent the set of test targets. Thus, to assign the correct test targets to different test steps, a label is added to the data structure of each test target in the set. In an example embodiment, the target manager 206 uses the combination of labels provided by the step manager 208 to select the proper test targets.

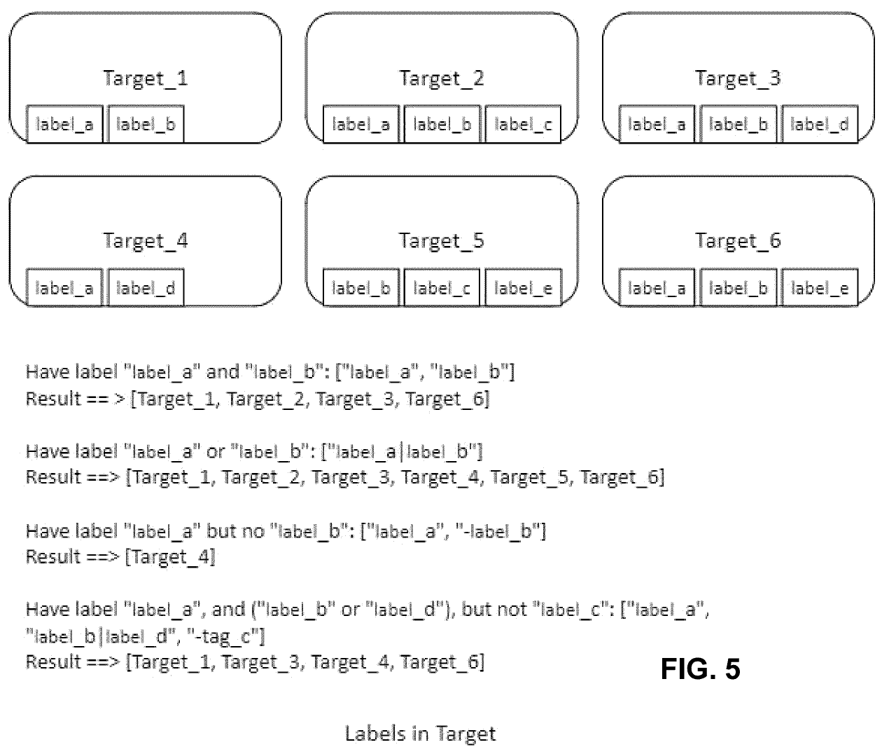

In an example embodiment, the data dictionary comprises at least one label. The one or more labels support at least one logical operator comprising at least one of “and”, “or”, and “not”. FIG. 5 illustrates labels within individual test targets.

In an example embodiment, other keys and values may be defined within the test target data structure.

In an example embodiment, the target manager 206 provides at least one test target function to control test targets. In an example embodiment, the test target functions comprise at least one of a test target add function, test target get function, and test target delete function, as illustrated below.

| | |
|---|---|
| TargetManager. get(labels, | Get test targets from test target pool |
| count=0) | labels: List of labels |
| | count: test target number to get |
| | 0 (int): Get all the proper test targets |
| | < 0 and <= 1 (float): Get % of the proper test targets |
| | For example, 0.5 means get 50% of the proper test targets. |
| | > 1 (int): Get {count} of the proper test targets. |
| | If there are no more than {count} proper test targets, get |
| | all of them. |
| | < 0 (int): Leave {count} of the proper test targets. |
| | For example, −1 means leave one proper test target, get |
| | others. |
| | If there are not enough proper test targets to leave, leave |
| | all of them. |
| TargetManager.add(target) | Add one test target to target manager |
| | target: The test target |
| TargetManager.delete(target) | Delete one test arget from target manager |
| | target: The test target |

In an example embodiment, the test script may randomly handle only parts of the test target. In this example scenario, the target_manager.get( ) function has a “count” attribute to support the random handling. Each test target has a unique identifier (UUID) to avoid repetition. In an example embodiment, the test target add function (i.e., target_manager.add( ) function) creates the unique identifier for the test target.

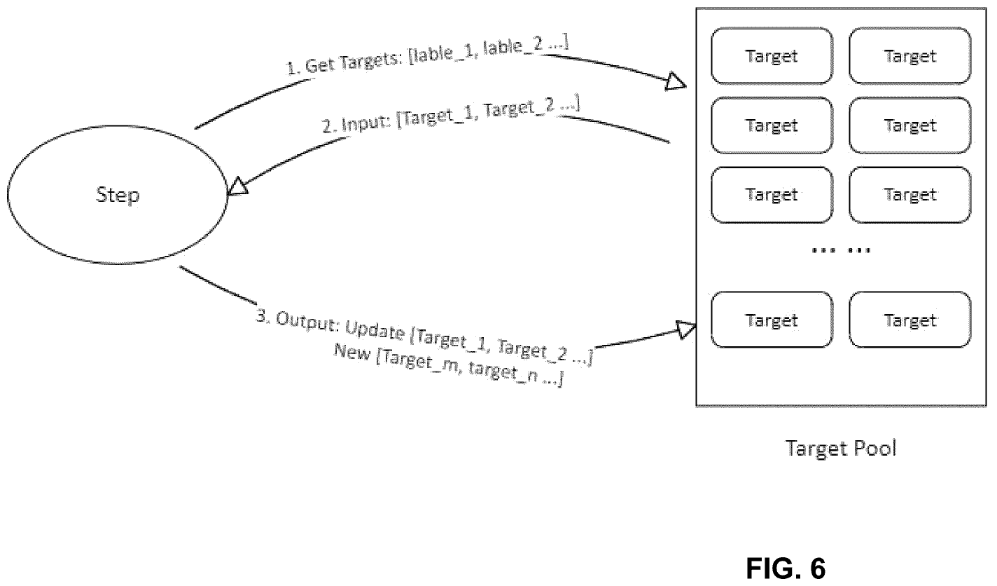

In an example embodiment, a test script comprises a plurality of test steps that perform an uninterrupted set of operations on a test target. A test step includes one or more test actions. FIG. 6 illustrates a test step performing operations on one or more test targets.

In an example embodiment, a step manager 208 manages execution of the test steps according to the DAG. In an example embodiment, the test step performs at least one test action on a test target. In an example embodiment, the test step receives, as input, the test target from the target manager 206. In an example embodiment, the test step updates the test target that is received as input from the target manager 206. In an example embodiment, the test step provides, as output, at least one new test target to the target manager. It is through the cooperation between the target manager 206 and step manager 208, that the test script coding system 105 optimizes globally managing the test objects.

In an example embodiment, the test script coding system 105 provides functions to create a test step object and a test step function, as illustrated below.

| | |
|---|---|
| Step.init(name, labels, fun, *args) | Init one step object |
| | name: name of the step |
| | labels: label list, support |
| | fun: the step function for test |
| | *args: Arguments of this real test function |
| fun(target_manager, target, ...) | Test step function for test |
| | target_manager: object of class TargetManager |
| | target: one target |

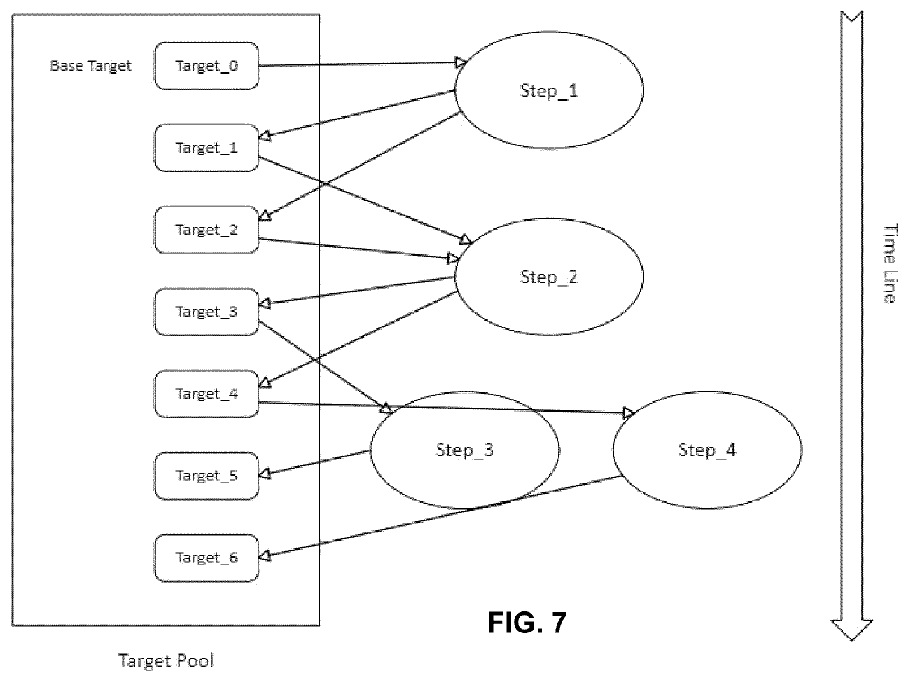

In an example embodiment, the test step uses test targets with labels to communicate with other test targets and uses relationships to define the test step execution timeline. This process makes it easy to design test scripts and to reusing individual test steps. In an example embodiment, the test step function focuses on one test target. FIG. 7 illustrates the interaction between test steps (i.e., “Step_1”, for example), and the test target pool.

In an example embodiment, the step manager 208 executes test steps according to an execution model, where the execution model comprises at least one of normal synchronous execution, exclusive synchronous execution, thread asynchronous execution, and threads asynchronous execution, where the test script coding system comprises the step manager. In real user scenarios, different test actions within the system have different characteristics. For example, some test actions should be executed separately after stopping all other actions, such as system power cycle, system maintenance, some test actions can be executed with other actions, such as customer IO, creating volume snapshot, some test actions process the objects one by one, such as rebooting the nodes one by one, recover the volume one by one, some test actions process the objects in parallel, such as customer IO on volumes, creating snapshot on many volumes at the same time, some test actions are synchronous, and some actions are asynchronous, such as initializing the system is synchronous action, but removing volumes is asynchronous action.

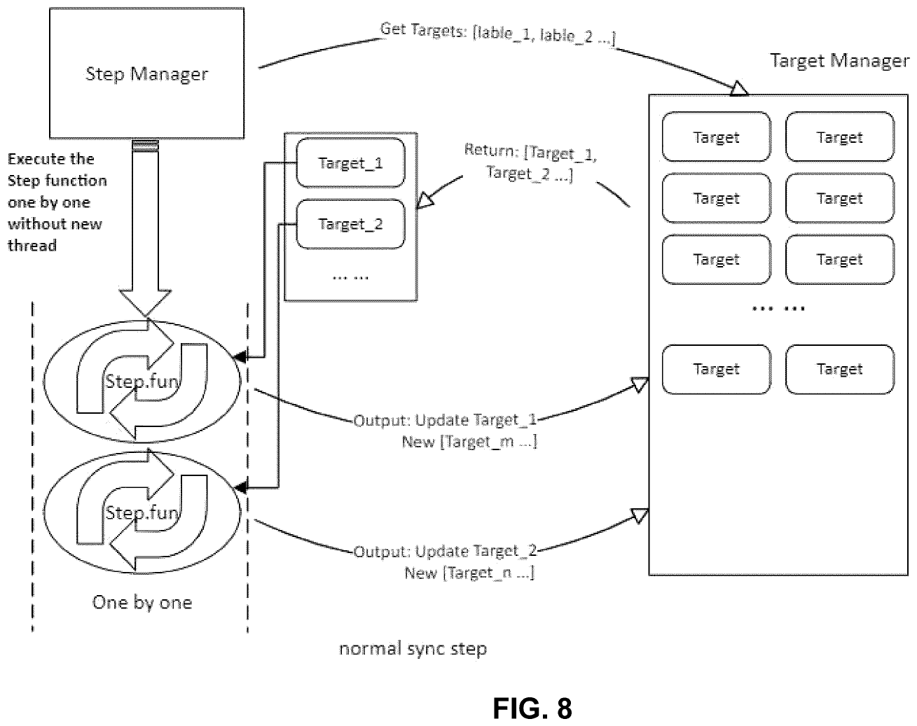

FIG. 8 illustrates the normal synchronous execution model. In this example embodiment, the step manager 208 executes the normal synchronous test step without starting a new thread. In other words, the step manager 208 starts the function of the test step to handle one test target, waits for the result, then starts the same function to handle the next test target. The step manager 208 completes the normal synchronous test step when all the test targets have been handled, and the results have been received.

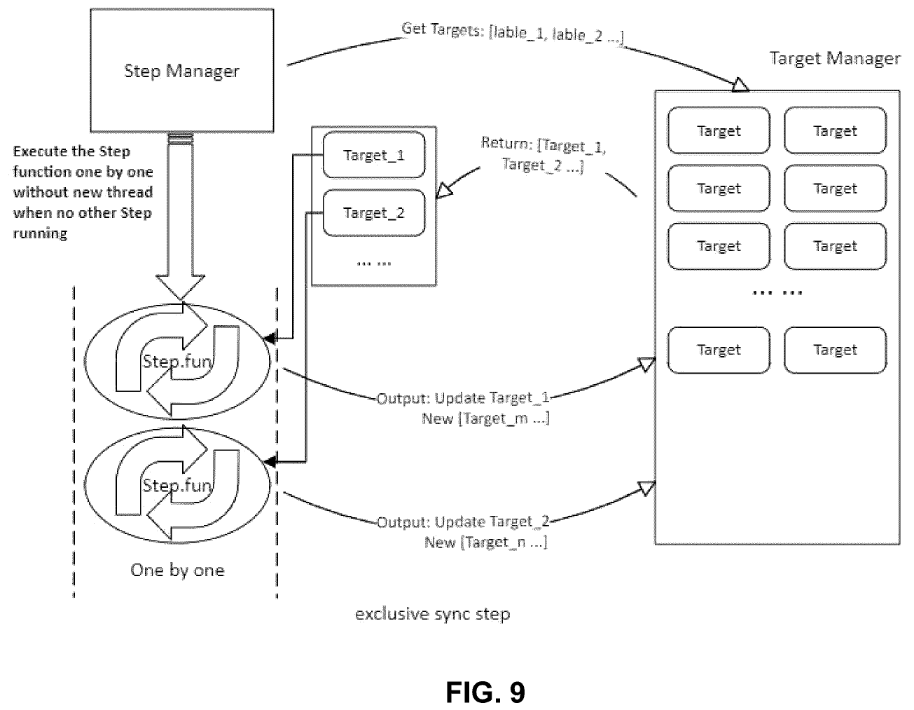

FIG. 9 illustrates the exclusive synchronous execution model. In this example embodiment, the execution logic is the same as the normal synchronous execution test step, but cannot be started if any test step is still in progress.

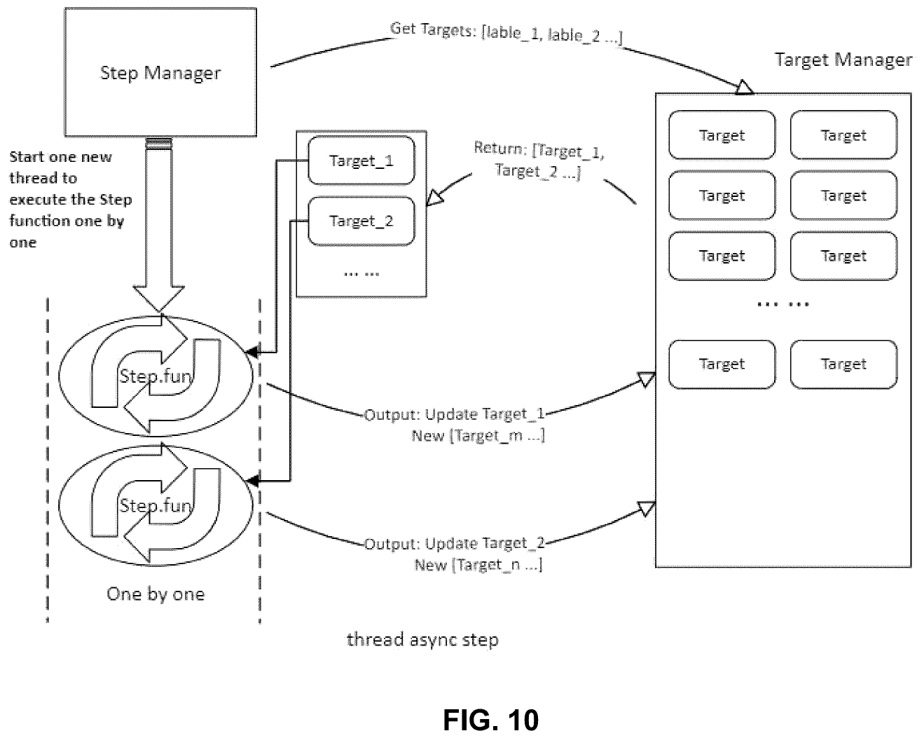

FIG. 10 illustrates the thread asynchronous execution model. In this example embodiment, the step manager 208 executes the thread asynchronous test step by starting only one new thread with the function of step, and this thread handles the test targets one by one. The step manager 208 doesn't wait for the result from the step function, and will try to start another ready test step after starting the current test step.

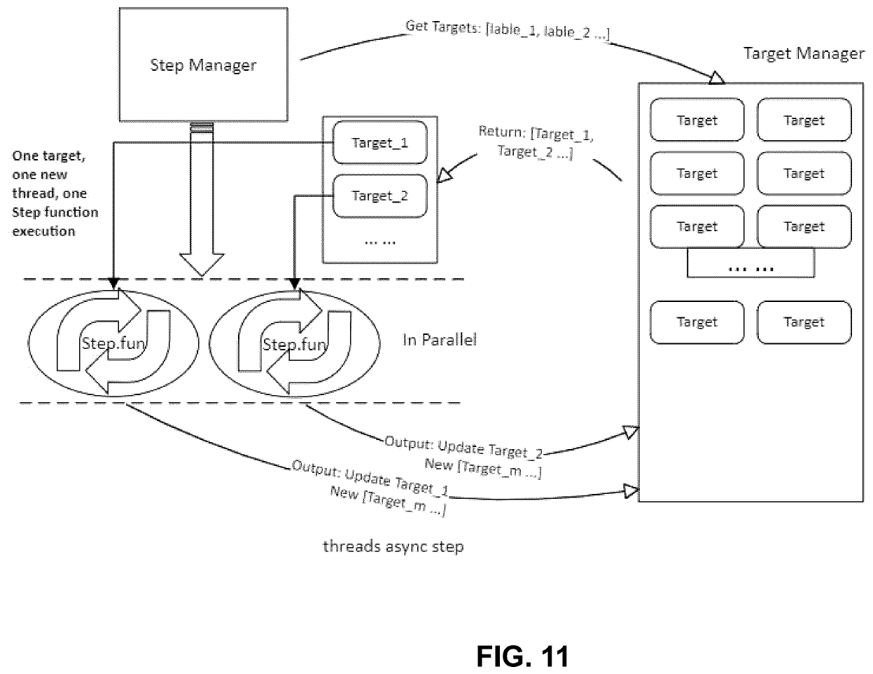

FIG. 11 illustrates the threads asynchronous execution model. In this example embodiment, the step manager 208 executes the threads asynchronous test step by starting many threads with the step function, where each thread handles one test target. The step manager 208 doesn't wait for the result of each thread, and will try to start another ready test step after starting the current test step.

In an example embodiment, the step function focuses on one test target, and does not have a return. The step function adds new test targets, or updates existing test targets to the target manager 206. Thus, the step function is highly reusable and applicable to different scenarios with different execution models. The test scripts are easier to design with many test steps because the designer of the test scripts does not have to worry about the connections between the test steps.

In an example embodiment, the test script coding system 105 defines at least one relationship in an execution timeline between one or more test steps. The relationship may include, but is not limited to a follow relationship, a conflict relationship and a wait relationship, where the relationship manages an execution order between the one or more test steps. In an example embodiment, there may be a requirement for there to be some relationship between the test steps within a timeline. For example, creating volumes must occur before a snapshot can be created on those volumes.

In an example embodiment, the follow relationship indicates that test step B follows test step A, meaning that test step B needs to wait for test step A to complete first. In an example embodiment, the conflict relationship indicates that test step B has a conflict with test step A, meaning that test step A and test step B cannot be executed at the same time. In an example embodiment, the wait relationship indicates that test step B waits for test step A, meaning that test step B will execute repeatedly until test step A is completed.

In an example embodiment, the main relationship between test steps is the follow relationship because it is used when creating the DAG. In an example embodiment, a test step can simultaneously have a follow relationship, a conflict relationship and a wait relationship. This allows the step manager 208 to simulate complex scenarios using the various relationships and test step execution models as described above.

In an example embodiment, the test script coding system 105 defines a global data structure comprising a key and value. In an example embodiment, the target manager 206 comprises the global data structure. FIG. 4 illustrates the global data structure, labelled “Blackboard”. In an example embodiment, the test step communicates with another test step using the global data structure. In an example embodiment, the global data structure is used to manage at least one of locks and messages used in communication between test steps. For example, if a portion of test code in a test step has a conflict with itself, or another portion of test code, a lock is added into Blackboard with an associated lock name. Test steps may obtain this lock from Blackboard using the associated lock name. The test steps request acquiring this lock before executing the conflicting test code, and the test steps release the lock after completing execution of the conflicting test code.

In another example, if an operation in one test step may cause the operations in other test steps to fail, a message is added to Blackboard with an associated name, before starting the operation that may cause failure. The message is then cleared after the operation (that may cause failure) is completed. In this example scenario, if the operations in other test steps failed, Blackboard may be accessed using the associated name. If the message is located in Blackboard, then the operations may be retried. Thus, the use of Blackboard allows communication between the test steps at the test step code level, and the test script designer does not have to consider this aspect when designing a test script that uses many test steps.

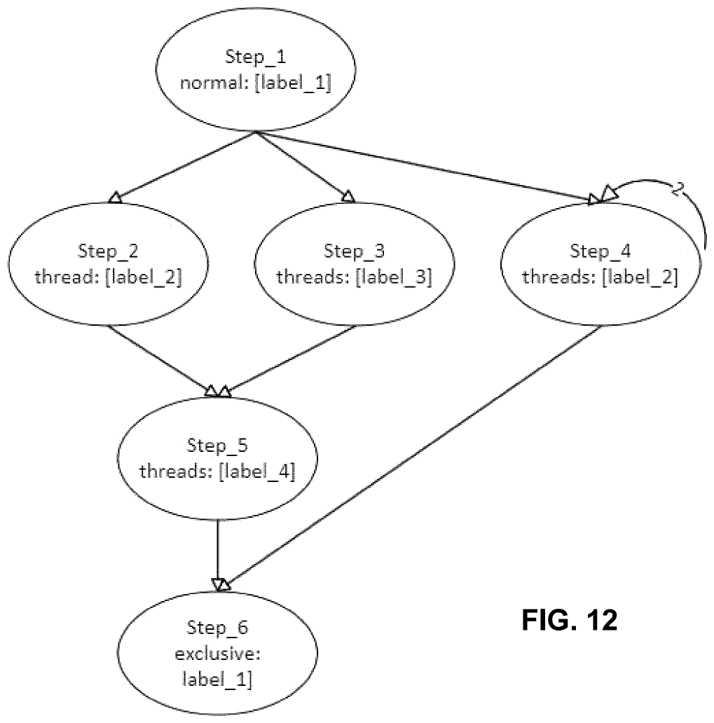

In an example embodiment, the test script coding system 105 creates a visual representation of the DAG representing a test structure of the test script. In an example embodiment, the target manager 206 removes the dependency on results between test steps and provides a test target pool for data communication between test steps. This makes it possible for the test step to become the vertex of the DAG. In an example embodiment, the main relationship between the test steps is “follow” and this is the edges between the vertices of the DAG. Thus, the DAG is generated in the step manager 208. In an example embodiment, the step manager 208 provides a method to generate the DAG to describe the entire test case structure. FIG. 12 illustrates the visual representation of the DAG created by the test script coding system 105. Using FIG. 12 as an example, the test steps are the vertices, and the “follow” relationships are the edges between the vertices. The graph generated by the test script coding system 105 is useful to test script designers because the test script structure is better understood, test script designers can leverage the DAG to design and develop test scripts, and the DAG helps product developers better understand the test case, aiding their efforts in debugging failures. Listed below is the test script code represented by the DAG graph in FIG. 12, followed by the functions used by the step manager 208.

# Create a StepManager object
step_manager = StepManager(“DAG example”)
# Create a TargetManager object
target_manager = TargetManager( )
# Add the original resource target to target_manager, it has labels: [“label_1”]
target_manager.add(base_target)
# Add a new Step object to StepManager
step_manager.add(Step(“Step_1”, [“label_1”], step_1))
# Config the new added Step object
step_manager.config(target_count=2, model=”normal”)
step_manager.add(Step(“Step_2”, [“label_2”], step_2))
step_manager.config(model=”thread”, follow=[“Step_1”])
step_manager.add(Step(“Step_3”, [“label_3”], step_3))
step_manager.config(model=”threads”, follow=[“Step_1”])
step_manager.add(Step(“Step_4”, [“label_2”], step_4))
step_manager.config(count=2, model=”threads”, follow=[“Step_1”])
step_manager.add(Step(“Step_5”, [“label_4”], step_5))
step_manager.config(model=”threads”, follow=[“Step_2”, “Step_3”,])
step_manager.add(Step(“Step_6”, [“label_1”], step_6))
step_manager.config(model=”exclusive”, follow=[“ Step_5”, “Step_4”])
step_manager. digraph ( )
step_manager.run(target_manager)

| | |
|---|---|
| StepManager.add(step) | Add new test step object to Step Manager |
| | Step: an object of class step |
| StepManager.config( ) | Configure the newly added test step |
| | Model: one value in [“normal”, “exclusive”, “thread”, |
| | “threads”] |
| | Follow: test step list, the test step must follow all the test |
| | steps in the list |
| | conflict: test step list, the test step conflicts with all the |
| | test steps in the list |
| | wait: test step list, the test step will be executed again and |
| | again until all test steps in this list are completed |
| | target_count: how many test targets will be selected. It |
| | has the same usage with the parameter count in |
| | TargetManager.get( ) |
| | count: how many times to run the test step |
| StepManager.digraph( ) | Generate a directed acyclic graph, the output is a file with |
| | png format |
| StepManager.run(target_manager) | Run the test case |
| | target_manager: an object of class TargetManager |

In an example embodiment, the step manager 208 performs an acyclic check for all of the test steps before starting execution of the test script. This is because the test script cannot be completed if there is an endless cycle in the test structure.

In an example embodiment, the test script coding system 105 executes the test script defined by the DAG. In an example embodiment, the step manager 208 executes the test step using the test step models described above; normal synchronous execution, exclusive synchronous execution, thread asynchronous execution, and threads asynchronous execution. In an example embodiment the step manager 208 executes the test step after the step manager 208 accesses the test step. For the test step model normal synchronous execution, the step manager 208 is required to wait for the test step to complete prior to accessing the subsequent test step. For the test step model thread asynchronous execution, the step manager 208 tries to access the subsequent test step, once the previous test step has been started.

Using FIG. 12 as an example, the access sequence is:
test step_1 is accessed first
randomly access one test step from the group of test steps 2, 3, and 4
randomly access another test step from the group of test steps 2, 3, and 4
randomly access another test step from the group of test steps 2, 3, and 4
. . .
test step 5 becomes ready after the execution of test step_2 and test step_3
test step_4 is executed twice
test step_6 becomes ready after the execution of test step_5 and the two executions of test step_4
test step_6 is the last test step to be executed.

A test step “becomes ready” if 1) that test step doesn't follow any other test step, or all the test steps it follows have been completed, and 2) all the test steps in its conflict list are not in the process of executing.

In an example embodiment, the step manager 208 randomly selects a “ready” test step from the list. This is useful in, for example, a system test, because there are many test situations, and it is hard to cover all of those test situations in one test execution cycle. Thus, the test situations can be distributed across multiple test cycles.

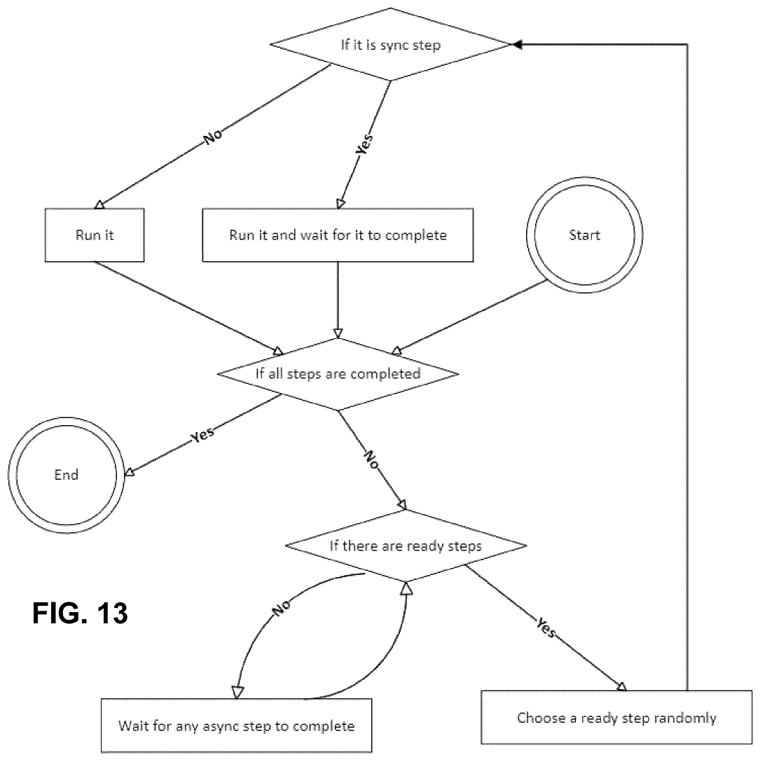

In an example embodiment, the step manager 208 executes the test steps in the DAG by traversing the vertices in the DAG. FIG. 13 illustrates the workflow.

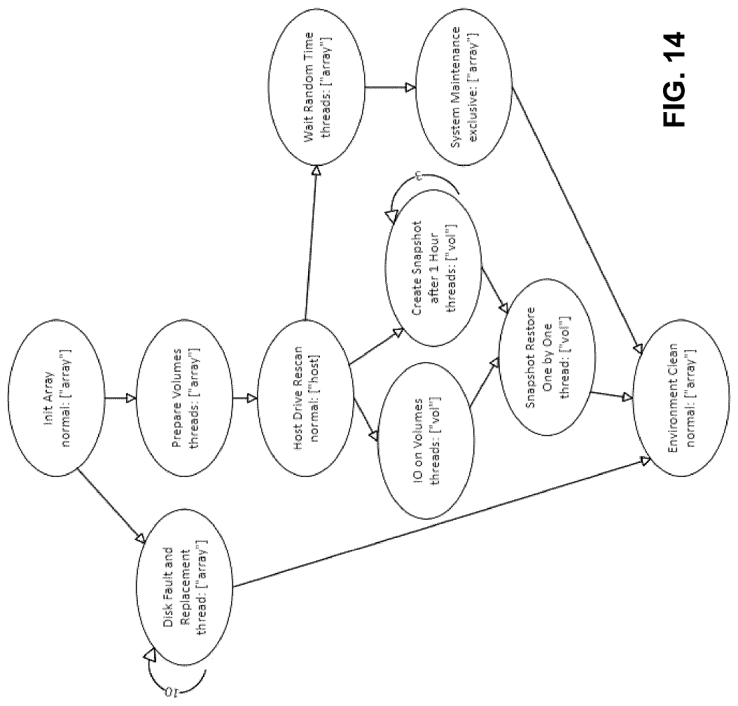

Using an example of a volume snapshot user scenario, an admin prepares the environment for the user. The users then write data and read data within the environment. The admin creates snapshots for each volume periodically, fixes disk issues, and occasionally performs system maintenance. At one point, the users' data is corrupted, and the admin, in response, assists in restoring the volume data from a snapshot previously created. Using the test script coding system 105, listed below is the code, and FIG. 14 illustrates the associated DAG. In this example scenario, system maintenance can happen at any time after preparing the environment, and is an “exclusive” operation.

# Create a StepManager object
step_manager = StepManager(“DAG example”)
# Create a TargetManager object
target_manager = TargetManager( )
# Add the original resource target to target_manager, it has labels: [“label_1”]
array_target = {″name″: array_name, ″obj″: arrayObject, labels: [′array′]}
target_manager.add(array_target)
host_target = {″name″: host_name, ″obj″: hostObject, labels: [′host′]}
target_manager.add(host_target)
step_manager.add(Step(“Init Array”, [“array”], init_array))
step_manager.config(model=”normal”)
step_manager.add(Step(“Disk Fault and Replacement”, [“array”], disk_fault, sleep_time=30))
step_manager.config(count=10, model=”thread”, follow=[“Init Array”])
step_manager.add(Step(“Prepare Volumes”, [“array”], prepare_volumes, vol_label=″vol″))
step_manager.config(model=”threads”, follow=[“Init Array””])
step_manager.add(Step(“Host Drive Rescan”, [“host”], host_rescan))
step_manager.config(model=”normal”, follow=[“Prepare Volumes”])
step_manager.add(Step(“IO on Volumes”, [“vol”], volume_io, duration=180))
step_manager.config(model=”threads”, follow=[“Host Drive Rescan”])
step_manager.add(Step(“Create Snapshot after 1 Hour”, [“vol”], volume_snap, sleep_time=60))
step_manager.config(count=3, model=”threads”, follow=[“Host Drive Rescan”])
step_manager.add(Step(“Wait Random Time”, [“array”], system_wait, time=”random”))
step_manager.config(model=”threads”, follow=[“Host Drive Rescan”])
step_manager.add(Step(“System Maintenance”, [“array”], system_maintenance))
step_manager.config(model=”exclusive”, follow=[“ Wait Random Time”])
step_manager.add(Step(“Snapshot Restore One by One”, [“vol”], snapshot_restore))
step_manager.config(model=”thread”, follow=[“IO on Volumes”, “Create Snapshot after 1
Hour”])
step_manager.add(Step(“Environment Clean”, [“vol”], remove_volumes))
step_manager.config(model=”exclusive”, follow=[“Disk Fault and Replacement”, “Snapshot
Restore One by One”, “System Maintenance”])
step_manager. digraph ( )
step_manager.run(target_manager)

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate test scripts to achieve efficient testing coverage. These and other embodiments can effectively create test scripts that truly mimic user scenarios where users may perform operations with some level of randomness, concurrently with other users. For example, embodiments disclosed herein create test scripts using a directed acyclic graph (DAG) that are flexible, adaptable, and scalable. Embodiments disclosed herein provide a framework that creates test scripts that communicate with other test scripts to coordinate operations to avoid bottlenecks. Embodiment disclosed herein provide a framework that adapts to more complex test scenarios, taking into account that the order of commands can greatly affect the outcome of a test script.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

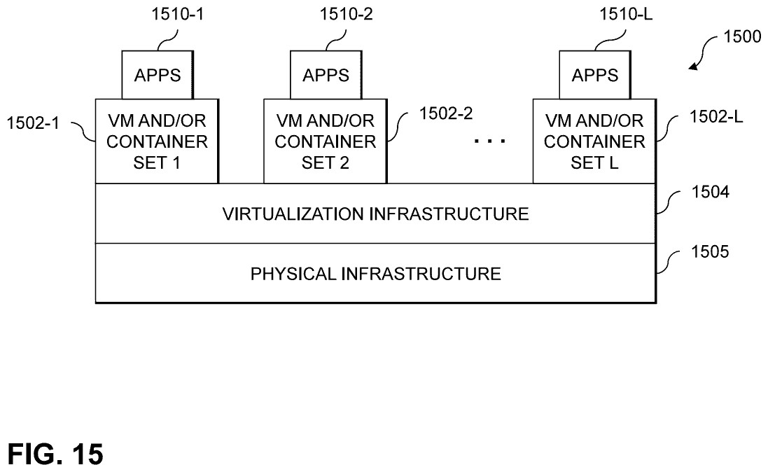

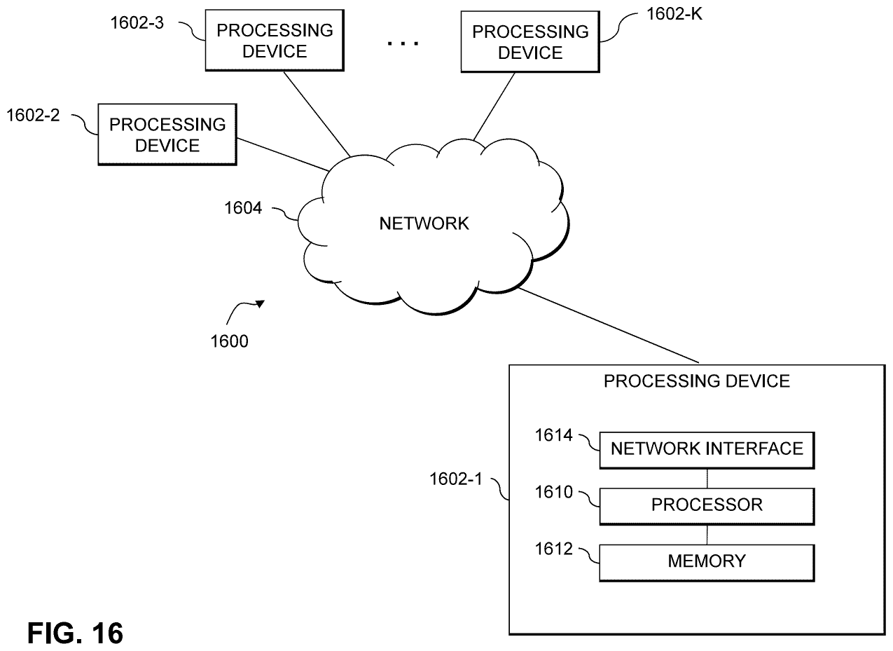

Illustrative embodiments of processing platforms will now be described in greater detail with reference to FIGS. 15 and 16. Although described in the context of the information processing system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that are utilized to implement at least a portion of the information processing system 100. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 comprise respective VMs, respective sets of one or more containers, or respective sets of one or more containers running in VMs. In some implementations of the FIG. 15 embodiment, the VMs/container sets 1502 comprise respective VMs implemented using virtualization infrastructure 1504 that comprises at least one hypervisor.

A hypervisor platform may be used to implement a hypervisor within the virtualization infrastructure 1504, where the hypervisor platform has an associated virtual infrastructure management system. The underlying physical machines comprise one or more distributed processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of the information processing system 100 and includes a plurality of processing devices, denoted 1602-1, 1602-2, 1602-3, . . . 1602-K, which communicate with one another over a network 1604.

The network 1604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1602-1 in the processing platform 1600 comprises a processor 1610 coupled to a memory 1612.

The processor 1610 comprises a microprocessor, a microcontroller, an application-specific integrated circuit (ASIC), a field-programmable gate array (FPGA) or other type of processing circuitry, as well as portions or combinations of such circuitry elements.

The memory 1612 comprises random access memory (RAM), read-only memory (ROM) or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request, by a test script coding system, to generate a test script for testing at least one test system; and
generating, by the test script coding system, a directed acyclic graph (DAG) representing test actions to execute during the testing, wherein the test script comprises test steps comprising the test actions, wherein the method is implemented by at least one processing device comprising a processor coupled to a memory.

2. The method of claim 1 further comprising:
creating, by the test script coding system, a visual representation of the DAG representing a test structure of the test script.

3. The method of claim 1 further comprising:
executing, by the test script coding system, the test script defined by the DAG.

4. The method of claim 1 wherein the DAG comprises vertices and edges, wherein the vertices comprise the test steps, and wherein the edges comprise relationships between the test steps.

5. The method of claim 1 wherein generating, by the test script coding system, the DAG comprises:
managing a plurality of test targets, by a target manager, wherein a test target comprises a data dictionary for a test object accessed by the test script during the execution of the test script, wherein the test script coding system comprises the target manager.

6. The method of claim 5 wherein the data dictionary comprises at least one label, wherein the at least one label supports at least one logical operator comprising at least one of “and”, “or”, and “not”.

7. The method of claim 5 wherein the target manager provides at least one test target function to control test targets.

8. The method of claim 7 wherein the at least one test target function comprises at least one of a test target add function, test target get function, and test target delete function.

9. The method of claim 8 wherein the test target add function creates a unique identifier for the test target.

10. The method of claim 8 wherein the test target get function comprises a count attribute.

11. The method of claim 1 wherein generating, by the test script coding system, the DAG comprises:
managing execution of the test steps, by a step manager, according to the DAG, wherein the test script coding system comprises the step manager, wherein the test step performs at least one test action on a test target.

12. The method of claim 1 wherein generating, by the test script coding system, the DAG comprises:
receiving as input, by the test step, the test target from a target manager, wherein the test script coding system comprises the target manager.

13. The method of claim 12 further comprising:
providing, as output, by the test step, at least one new test target to the target manager.

14. The method of claim 12 further comprising:
updating, by the test step, the test target that is received as input from the target manager.

15. The method of claim 1 wherein generating, by the test script coding system, the DAG comprises:
executing, by a step manager, test steps according to an execution model, wherein the execution model comprises at least one of normal synchronous execution, exclusive synchronous execution, thread asynchronous execution, and threads asynchronous execution, wherein the test script coding system comprises the step manager.

16. The method of claim 1 wherein generating, by the test script coding system, the DAG comprises:
defining, by the test script coding system, at least one relationship in an execution timeline between one or more test steps, wherein the at least one relationship comprises a follow relationship, a conflict relationship and a wait relationship, wherein the at least one relationship manages execution order between the one or more test steps.

17. The method of claim 1 wherein generating, by the test script coding system, the DAG comprises:
defining, by the test script coding system, a global data structure comprising a key and value, wherein a step manager comprises the global data structure, wherein the test step communicates with another test step using the global data structure, and wherein the test script coding system comprises the step manager.

18. The method of claim 17 wherein the global data structure is used to manage at least one of locks and messages used in communication between test steps.

19. A system comprising:
at least one processing device comprising a processor coupled to a memory;
the at least one processing device being configured:
to receive a request, by a test script coding system, to generate a test script for testing at least one test system; and
to generate, by the test script coding system, a directed acyclic graph (DAG) representing test actions to execute during the testing, wherein the test script comprises test steps comprising the test actions.

20. A computer program product comprising a non-transitory processor-readable storage medium having stored therein program code of one or more software programs, wherein the program code when executed by at least one processing device causes said at least one processing device:
to receive a request, by a test script coding system, to generate a test script for testing at least one test system; and
to generate, by the test script coding system, a directed acyclic graph (DAG) representing test actions to execute during the testing, wherein the test script comprises test steps comprising the test actions.
